(19) United States
(12) Patent Application Publication
(10) Pub. No.: US 2007/0162959 A1
(43) Pub. Date: Jul. 12, 2007

(54) METHOD OF SUPPORTING COMMUNICATION SERVICE AND COMMUNICATION TERMINAL THEREFOR

(75) Inventor: Seung Jei Yang, Seoul (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/611,740

(22) Filed: Dec. 15, 2006

(30) Foreign Application Priority Data
Dec. 15, 2005 (KR) 10-2005-0123809

(51) Int. Cl. H04L 9/32

(52) U.S. Cl. 726/4; 340/825.52; 713/170; 709/229

(57) ABSTRACT

A method of supporting a communication service and communication terminal therefore are disclosed, by which the communication service can be supported at a reliable server address. The present invention includes a first message transmitting unit configured to transmit a request message to request for a server address, a first message receiving unit configured to receive a first response message, a second message transmitting unit configured to transmit a confirmation message, a second message receiving unit configured to receive a second response message indicating an authentication result of the address value in response to the confirmation message, and a control unit configure to extract the address value included in the first response message, insert the extracted address value in the confirmation message, and control access to a network based the authentication result indicated by the second response message.

This application claims the benefit of the Korean Patent Application No. 10-2005-0123809, filed on Dec. 15, 2005, which is hereby incorporated by reference as if fully set forth herein.

### BACKGROUND OF THE INVENTION

1. Field of the Invention

The present invention relates to a method of supporting a communication service and communication terminal therefor.

2. Discussion of the Related Art

Generally, a communication terminal supports or provides various communication services. One of the communication services supported by the communication terminal is a packet switching data service.

The communication terminal needs an address of a domain name server (DNS) to use a packet switching data service. The network then provides the corresponding DNS address to the communication terminal. Subsequently, the communication terminal attempts the packet switching data service using the DNS address provided by the network.

However, according to the conventional art, it is difficult for the communication terminal to discern whether the DNS address received from the network is the correct address or not. Therefore, the communication terminal assumes that the DNS address received from the network is a correct address.

Even though the DNS address provided by the network is incorrect, the communication terminal attempts the packet switching data service using the incorrect DNS address provided without knowing that the DNS address is incorrect. As such, the network is unable to provide the communication terminal with the requested service, and as a result, incorrect service may be provided.

Further, even if the communication terminal makes a request for the packet switching data service with the incorrect DNS address, the network assigns a specific channel in response to the request for the packet switching data service. Therefore, according to the related art, network resources are wasted and network efficiency suffers.

### SUMMARY OF THE INVENTION

Accordingly, the present invention is directed to a method of supporting a communication service and communication terminal therefor that substantially obviate one or more problems due to limitations and disadvantages of the related art.

An object of the present invention is to provide a method of supporting a communication service and communication terminal therefore, by which the communication service can be supported at a reliable server address.

Another object of the present invention is to provide a method of supporting a communication service and communication terminal therefore, by which a DNS address required fro a packet switching data service can be obtained more accurately.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a communication terminal, which supports a communication service, according to the present invention includes a first message transmitting unit configured to transmit a request message to request for a server address of the communication service, a first message receiving unit configured to receive a first response message as a response to the request message, a second message transmitting unit configured to transmit a confirmation message for an authentication of an address value included in the first response message, a second message receiving unit configured to receive a second response message indicating an authentication result of the address value in response to the confirmation message, and a control unit configured to extract the address value included in the first response message, insert the extracted address value in the confirmation message, and control an access to a network providing the communication service based on the authentication result indicated by the second response message

Preferably, the server address is an address of a domain name server (DNS) to provide the communication service.

Preferably, the request message is a packet data protocol context request message.

Preferably, the first response message is a packet data protocol context response message.

More preferably, the first response message includes a first field including the address value and a second field indicating acceptance of the address value included in the first field.

More preferably, the first field is a domain name server field including an address value of a domain name server to provide the communication service.

More preferably, the second field is a protocol configure option field indicating the acceptance of the address value included in the first field.

Preferably, the authentication result indicated by the second response message is a result based on comparing the server address transmitted as the response to the request message by the network and the address value included in the confirmation message by comparison.

Preferably, the communication service is a packet switching data service.

Preferably, if the authentication result indicated by the second response message is an affirmative response, the control unit attempts an access to the network.

In another aspect of the present invention, a communication terminal, which supports a packet switching data service, includes a first receiving unit configured to receive a request message requesting a server address required for use of the service, a first transmitting unit configured to transmit a first response message including the server address in response to the request message, a second receiving unit configured to receive a confirmation message requesting an authentication of a specific address value, a second transmitting unit configured to transmit a second response message indicating an authentication result for an address value included in the confirmation message in response to the confirmation message, and a control unit configured to extract the address value included in the confirmation message, compare the extracted address value to the server address transmitted via the first response message, determine whether the extracted address value corresponds to the server address, and generate a second response message indicating a result of the decision.

Preferably, the server address is an address of a domain name server for the service.

Preferably, the request message is a packet data protocol context request message.

Preferably, the first response message is a packet data protocol context response message.

More preferably, the first response message includes a first field including the server address and a second field indicating acceptance of the server address included in the first field.

Preferably, if the address value extracted from the confirmation message is a value corresponding to the server address transmitted via the first response message, the control unit generates the second response message to indicate an affirmative response.

Preferably, by confirming an identification number of a transmitting terminal from the request message and the confirmation message, the first and second response messages are transmitted to the identification number.

In another aspect of the present invention, a method of supporting a communication service includes the steps of making a request to a network for a server address required for using the communication service, receiving a first response message including a specific address value from the network in response to the request, requesting to the network for an authentication for the address value included in the first response message, receiving a second response message indicating a result of the authentication from the network, and accessing the network using the address value included in the first response value if the authentication result indicated by the second response message is affirmative.

Preferably, the address value corresponds to an identification number of a domain name server for the communication service.

Preferably, the communication service is a packet switching data service.

In another aspect of the present invention, a method of supporting a communication service includes if a request message requesting a server address is received, transmitting a response message including the server address to a corresponding communication terminal, if a confirmation message requesting an authentication is received from the communication terminal, comparing an address value included in the confirmation message to the server address, and if the address value corresponds to the server address, providing an affirmative response to indicate validity of the server address to the communication terminal.

Preferably, the server address corresponds to an identification number of a domain name server for the communication service.

Preferably, the communication service is a packet switching data service.

More preferably, the request message and the response message are packet data protocol context messages for the packet switching data service, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram of configurations of a terminal and network for a communication service according to the present invention;

FIG. 2 is a flowchart of a process for obtaining a reliable server address and supporting a service in a communication terminal according to one embodiment of the present invention;

FIG. 3 is a flowchart of a service supporting process in a server according to one embodiment of the present invention; and

FIG. 4 is a flowchart of a process for obtaining a reliable DNS address and supporting a service between a communication terminal and a server according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts,

A communication terminal according to the present invention supports a communication service, and more specifically, a packet switching data service. Further, a network provides the communication service to the communication terminal, and more specifically, the packet switching data service.

In order to initiate the packet switching data service, the communication terminal makes a request to the network for a DNS address. In response, the network provides the communication terminal with the DNS address.

The communication terminal initiates the packet switching data service using the DNS address received from the network.

Prior to initiating the packet switching data service, the communication terminal checks value(s) of the received addressees) to determine whether the DNS address provided by the network is the correct address or not. To this end, the communication terminal makes a request to the network for authentication of the DNS address. The authentication is to determine reliability for the DNS address by matching the address values.

In the description(s) of the present invention, it is preferable that a server address is a DNS address.

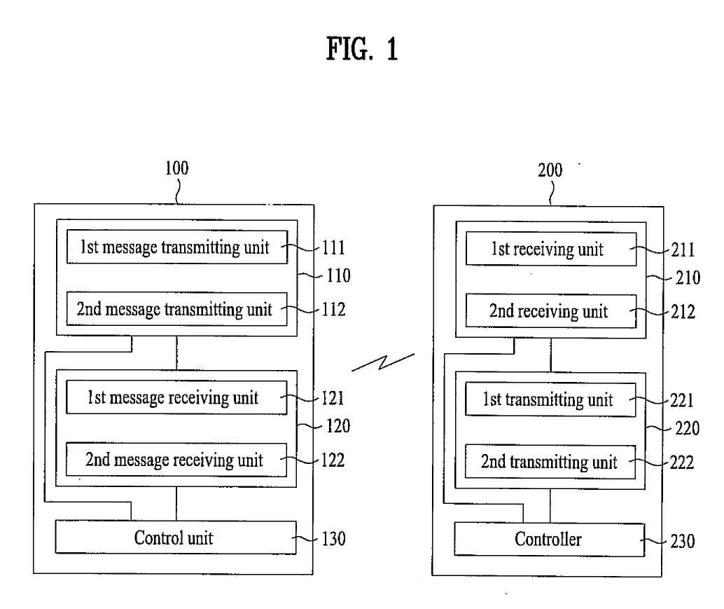

FIG. 1 is a block diagram of configurations of a terminal and a network for a communication service according to the present invention.

Referring to FIG. 1, a communication terminal 100 includes a message transmitting unit 110 for transmitting a a request message for a server address and a request message for an address value authentication, and a message receiving unit 120 for receiving a response message to the server address request and a response message for the address value authentication request.

The message transmitting unit 110 includes a first message transmitting unit 111 for transmitting the request message for the server address, and a second message transmitting unit 112 for transmitting the request message for the authentication for a specific address value.

In addition, the message receiving unit 120 includes a first message receiving unit 121 for receiving a first response message including an address value in response to the server address request, and a second message receiving unit 122 for receiving a second response message indicating an authentication result in response to the authentication request for the specific address value.

Here, the request message for the server address is a packet data protocol context request message, and the first response message in response to the server address request is a packet data protocol context response message.

The communication terminal 100 further includes a control unit 130 for performing control functions related to reception and transmission of a message in the message receiving unit 120 and the message transmitting unit 110, respectively. The control unit 130 can be used to participate in generation of messages transmitted via the message transmitting unit 110.

In operation, the control unit 130 extracts the address value from the first response message received by the first message receiving unit 121. The control unit 130 then includes the extracted address value in a confirmation message. Here, the confirmation message is to request for an authentication of the inserted address value. Further, the control unit 130 controls an access to a network of the communication terminal 100 by referring to the authentication result indicated by the second response message received by the second message receiving unit 122.

A network 200 providing a communication service to the communication terminal 100 includes a receiving unit 210 for receiving the request message for the server address, and the request message for the specific address value authentication. The network 200 further includes a transmitting unit 220 for transmitting the response message to the server address request, and the response message to the authentication request for the address value

More specifically, the receiving unit 210 includes a first receiving unit 211 for receiving the request message for the server address from the communication terminal 100, and a second receiving unit 212 for receiving the confirmation message to the request for the authentication of the specific address value from the communication terminal 100.

In addition, the transmitting unit 220 includes a first transmitting unit 221 for transmitting to the communication terminal 100 the first response message, including the requested address value as a response, for the server address request, and a second transmitting unit 222 for transmitting to the mobile communication terminal 100 the second response message indicating the authentication result as a response to the authentication request for the specific address value.

Here, the first receiving unit 211 receives a packet data protocol context request message, and the first transmitting unit 221 transmits a packet data protocol context response message.

The network 200 further includes a controller 230 for performing control functions related to a message reception and transmission by the receiving unit 210 and the transmitting unit 220, respectively. Furthermore, the controller 230 can be used to participate in generation of messages transmitted via the transmitting unit 220.

As the request message for requesting the server address is received by the first receiving unit 211, the controller 230 includes the requested address value in the first response message.

As the confirmation message for requesting the authentication of the specific address value is received by the second receiving unit 212, the controller 230 extracts the address value to be authenticated from the received confirmation message.

The controller 230 performs an authentication on the extracted address value. In particular, the controller 230 determines whether the addresses match by comparing the extracted address value to the server address which was transmitted to the communication terminal 100. Further, the controller 230 controls the authentication result to be notified to the communication terminal 100. In particular, the controller 230 controls the second transmitting unit 222 to transmit the second response message indicating the authentication result.

If the address value extracted from the confirmation message corresponds to the server address which was transmitted to the communication terminal 100 via the first response message, the controller 230 generates a response message indicating an affirmative response (ACK). Subsequently, the second transmitting unit 230 transmits the second response message indicating the affirmative response (ACK) to the communication terminal 100.

On the other hand, if it is decided that the address value extracted from the confirmation message is different from the server address having been transmitted to the communication terminal 100 via the first response message, the controller 230 generates a response message indicating a negative response (NAK). Subsequently, the second transmitting unit 222 transmits the second response message indicating the negative response (NACK) to the communication terminal 100.

The controller 230 confirms an identification number of the communication terminal from the message of the request for the server address and then transmits the first response message to the confirmed identification number. The controller confirms the identification number of the communication terminal from the confirmation message and then transmits the second response message to the confirmed identification number.

Meanwhile, in case of receiving the response message indicating the affirmative response (ACK) from the network 200, the communication terminal 100 attempts an access to the network 200 using a corresponding server address. In case of receiving the response message indicating the negative response (NACK) from the network 200, the communication terminal 100 is preferably deactivated for the communication service or preferably reattempts a procedure for obtaining a server address from the network 200.

If the communication terminal 100 attempts to access the network using the authenticated server address, the network 200 provides a corresponding communication service to the communication terminal 100.

Preferably, the above-configured network 200 is regarded as one server.

The packet data protocol context request message used in requesting a server address includes a field for setting a server address value. For instance, when the communication terminal 100 requests a server address, the field is set to a default address value. As an example of the default address value, ‘0,0,0,0’ can be used.

In addition, the packet data protocol context response message used as a response to a server address request includes a first field to set a requested server address value and a second field indicating acceptability for the address value contained in the first field, i.e., whether the address value contained in the first field is acceptable or not acceptable.

In particular, the server address value set in the first field corresponds to a DNS address. Moreover, the second field is a protocol configure option (PCO) field. Further, a PCO type indicating acceptability of the DNS address. In particular, the PCO type is classified into ‘configure-ack’, ‘configure-nak’ and ‘configure-reject’.

If the PCO type is ‘configure-ack’, it indicates that the address value set in the packet data protocol context request message is used as the first field value. That is, in case of ‘configure-ack’, the address value set in the data protocol context request message is accepted as the first field value.

For instance, assuming that the address value set in the packet data protocol context request message is ‘0,0,0,0’, if the PCO type of the packet data protocol context response message is ‘configure-ack’, ‘0,0,0,0,’ should be accepted as the value of the first field only. Further, in case of ‘configure-ack’, if the value of the first field is ‘0,0,0,0’, it is ‘True’. In other words, the PCO type is “configure-ack,’ the first field should indicate ‘0,0,0,0.’ If it does not, then it is ‘False’ and considered incorrect. To put differenty, if the PCT type is ‘configure-ack’ but the value of the first field is not ‘0,0,0,0’, it can only be ‘True’ if the PCO type is ‘configure-nak’.

Consequently, if ‘configure-ack’, the address value of the first field is not a new value. Therefore, the communication terminal 100 is preferably deactivated or preferably reattempts the procedure for obtaining the server address from the network 200.

If the PCO type is ‘configure-nak’, it indicates that a value different from the address value set in the packet data protocol context request message is used as an address value of the first field. That is, it indicates that the address value set in the packet data protocol context request message is not used as the first field value in case of ‘configure-nak’.

For instance, assuming that the address value set in the packet data protocol context request message is ‘0,0,0,0’, if the PCO type of the packet data protocol context response message is ‘configure-nak’, a value different from ‘0,0,0,0’ should be used as the value of the first field. As such, in case of ‘configure-nak’, if the value of the first field is ‘0,0,0,0’, it is ‘False’. As discussed, the value of the first field other than ‘0,0,0,0’ should be used in order to make this ‘True’.

If the PCO type is ‘configure-reject’, it indicates that the identification information authentication for the communication terminal 100 having transmitted the packet data protocol context request message failed.

In the present invention, a correct DNS address associated with PCO in a third generation network is obtained from the above configurations.

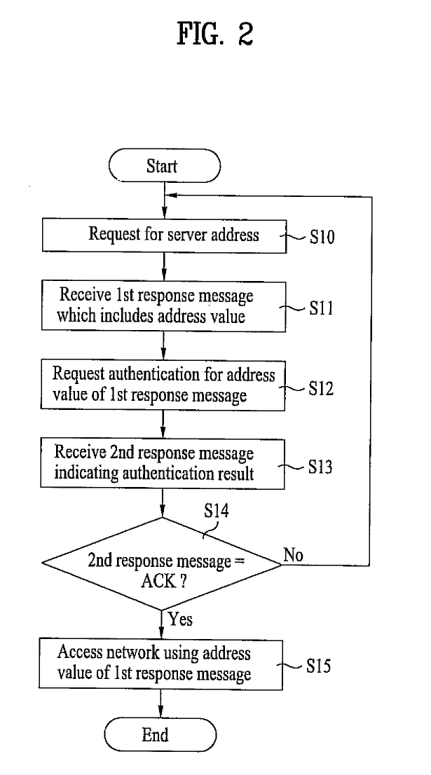

FIG. 2 is a flowchart of a process for obtaining a reliable server address and supporting a service in a communication terminal according to one embodiment of the present invention.

Referring to FIG. 2, a communication terminal makes a request to a network for a server address to use a communication service (S10). More specifically, the communication terminal transmits a packet data protocol context request message for a server address request to the network.

In response, the communication terminal receives a first response message including a server address value to the request for the server address (S11). Here, the first response message is a packet data protocol context response message.

Thereafter, the communication terminal checks acceptability for the address value included in the first response message. If a result of the check corresponds to a specific case, the communication terminal makes a request to the network to authenticate the address value included in the first response message (S12). In other words, the communication terminal confirms a PCO type of the packet data protocol context response message. If the PCO type is ‘configure-nak’, the communication terminal determines authenticity of the address value included in the packet data protocol context response message to the network.

For the authentication request, the communication terminal extracts the address value included in the first response message. The communication terminal then inserts or includes the extracted address value in a confirmation message. Finally, the communication terminal transmits the confirmation message including the extracted address value to the network.

In response, the communication terminal receives a second response message indicating the result of the authenticity confirmation of the address value to the authentication request (S13).

The communication terminal then accesses the network based on the authentication result indicated by the second response message (S15).

More specifically, the communication terminal checks whether the authentication result indicated by the second response message is an affirmative response (ACK) or a negative response (NAK) (S14).

If the second response message is the affirmative response (ACK), the communication terminal accesses the network using the address value included in the first response message (S15). In other words, the communication terminal accesses the network that provides a packet switching data service using a DNS address succeeding in the authentication using the above process.

If the second response message is the negative response (NAK), the communication terminal is deactivated from the communication service or performs a procedure for obtaining a server address again.

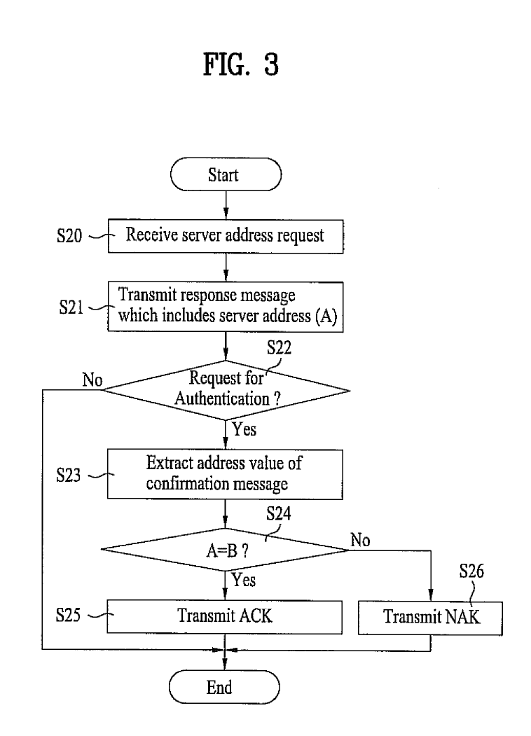

FIG. 3 is a flowchart of a service supporting process in a server according to one embodiment of the present invention.

Referring to FIG. 3, a network receives a request for a server address from a communication terminal (S20). To put differently, the network receives a packet data protocol context request message for a server address request from the communication terminal.

The network transmits a first response message including the server address (A) to the communication terminal in response to the request for the server address (S21). Here, the first response message is a packet data protocol context response message.

The network sets one of the PCO types in the packet data protocol context response message and includes at least one sever address of the packet data protocol context response message.

If an authentication request for a specific address value is made by the communication terminal (S22), the network executes an authentication procedure for a corresponding address value (S23-S24).

Further, if a confirmation message including the specific address value from the communication terminal is received, the network extracts an address value (B) from the confirmation message (S23).

Thereafter, the server address (A) included in the first response message is compared to the address value extracted from the confirmation message (S24).

If the extracted address value (B) corresponds to the server address (A) in the first response message, the network transmits a message indicating an affirmative response (ACK) to the communication terminal (S25).

If the extracted address value (B) does not correspond to the server address (A) in the first response message, the network transmits a message indicating a negative response (NAK) to the communication terminal (S26).

Hence, in response to the authentication request for the specific address value, the second response message transmitted to the communication terminal indicates either the affirmative response (ACK) or the negative response (NAK)

The network provides corresponding communication service to the communication terminal by using the authenticated address value to access the network.

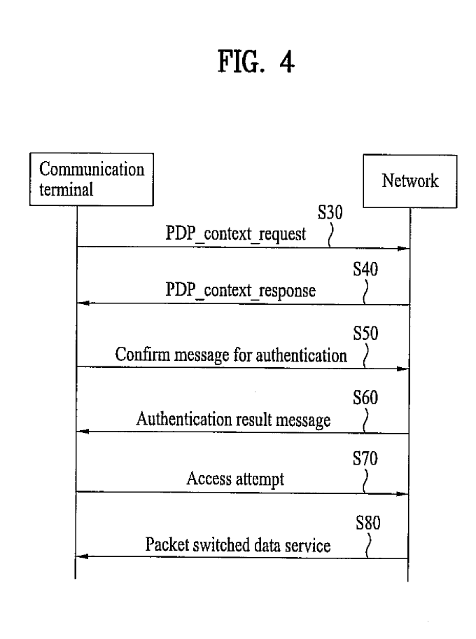

FIG. 4 is a flowchart of a process for obtaining a reliable DNS address and supporting a service between a communication terminal and a server according to one embodiment of the present invention.

Referring to FIG. 4, a communication terminal transmits a packet data protocol context request message to a network requesting for a DNS address in order to use a packet switching data service (S30).

In response to the packet data protocol context request message, the network transmits to the communication terminal a packet data protocol context response message, in which a PCO type is set and a DNS address value is included (S40). Here, the network confirms an identification number of the communication terminal from the packet data protocol context request message and then transmits a response message to the confirmed identification number.

The communication terminal then checks a PCO type of the packet data protocol context response message. If the DNS address value included in the response message is confirmed as a valid address value, the communication terminal makes a request for an authentication of the DNS address value included in the response message to the network.

For the authentication of the DNS address value, the communication terminal transmits a confirmation message including the DNS address value of the packet data protocol context response message to the network (S50).

In case of receiving the confirmation message including the DNS address value from the communication terminal, the network extracts the DNS address value from the confirmation message. The network then compares to determine whether the address value in the confirmation message corresponds to the DNS address value in the packet data protocol context response message.

The network transmits an authentication result message according to a result of the comparison to the communication terminal (860). More specifically, if the address value in the confirmation message corresponds to the DNS address value in the packet data protocol context response message, the network transmits an authentication result message indicating an affirmative response (ACK) to the communication terminal. Otherwise, the network transmits an authentication result message indicating a negative response (NAK) to the communication terminal.

As the authentication result message indicates the affirmative response (ACK), the communication terminal attempts an access to the network at the DNS address value in the packet data protocol context response message (S70).

The network then provides a packet switching data service to the accessed communication terminal (S80).

For instance, it is assumed that a DNS address value is requested in a manner of setting an address field of a packet data protocol context request message to ‘0,0,0,0’.

The network confirms an address field in the packet data protocol context response message and then sets a PCO type and a DNS address in the address field.

The network transmits a packet data protocol context response message. Here, the packet data protocol context response message has a PCO type of ‘configure-nak’ and the address field in the packet data protocol context response message is set to ‘A,B,C,D’.

The communication terminal extracts the DNS address value from the packet data protocol context response message. Here, it is assumed that the extracted address value is ‘a,b,c,d’.

For an authentication of the extracted address value ‘a,b,c,d’, a confirmation message including the address value ‘a,b,c,d’ is transmitted to the network.

The network extracts the address value ‘a,b,c,d’ from the received confirmation message received from the communication terminal and then compares the extracted address value ‘a,b,c,d’ to the address value ‘A,B,C,D’ transmitted to the communication terminal via the packet data protocol context response message.

If the address values ‘a,b,c,d’ and ‘A,B,C,D’ are the same, the network transmits an authentication result message indicating an affirmative response (ACK) to the communication terminal. Otherwise, the network transmits an authentication result message indicating a negative result to the communication terminal.

In case of receiving the authentication result message indicating the affirmative response from the network, the communication terminal initiates a packet switching data service using the address value ‘A,B,C,D=a,b,c,d’.

Accordingly, the present invention provides the following effects or advantages. Namely, a requested DNS address can be obtained more accurately. Since a reliable server address is secured, a specific communication service can be reliably supported. In addition, waste of network resources can be minimized. Further, efficiency of the network can be improved for communication services.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A communication terminal, which supports a communication service, comprising:
a first message transmitting unit configured to transmit a request message to request for a server address of the communication service;
a first message receiving unit configured to receive a first response message as a response to the request message;
a second message transmitting unit configured to transmit a confirmation message for an authentication of an address value included in the first response message;
a second message receiving unit configured to receive a second response message indicating an authentication result of the address value in response to the confirmation message; and
a control unit configured to extract the address value included in the first response message, insert the extracted address value in the confirmation message and control access to a network providing the communication service based on the authentication result.

2. The communication terminal of claim 1, wherein the server address is an address of a domain name server (DNS) to provide the communication service.

3. The communication terminal of claim 1, wherein the request message is a packet data protocol context request message.

4. The communication terminal of claim 1, wherein the first response message is a packet data protocol context response message.

5. The communication terminal of claim 4, the first response message comprising:
a first field including the address value; and
a second field indicating acceptance of the address value included in the first field.

6. The communication terminal of claim 5, wherein the first field is a domain name server field including an address value of a domain name server to provide the communication service.

7. The communication terminal of claim 5, wherein the second field is a protocol configure option field indicating the acceptance of the address value included in the first field.

8. The communication terminal of claim 1, wherein the authentication result indicated by the second response message is a result based on comparing the server address transmitted as the response to the request message by the network and the address value included in the confirmation message.

9. The communication terminal of claim 1, wherein the communication service is a packet switching data service.

10. The communication terminal of claim 1, wherein if the authentication result indicated by the second response message is an affirmative response, the control unit attempts to access the network.

11. A communication terminal, which supports a packet switching data service, comprising:
a first receiving unit configured to receive a request message requesting a server address required for use of the service;
a first transmitting unit configured to transmit a first response message including the server address in response to the request message;
a second receiving unit configured to receive a confirmation message requesting an authentication of a specific address value;
a second transmitting unit configured to transmit a second response message indicating an authentication result for an address value included in the confirmation message in response to the confirmation message; and
a control unit configured to extract the address value included in the confirmation message, compare the extracted address value to the server address transmitted via the first response message, determine whether the extracted address value corresponds to the server address, and generate a second response message indicating a result of the decision.

12. The communication terminal of claim 11, wherein the server address is an address of a domain name server for the service.

13. The communication terminal of claim 11, wherein the request message is a packet data protocol context request message.

14. The communication terminal of claim 11, wherein the first response message is a packet data protocol context response message.

15. The communication terminal of claim 14, the first response message comprising:
a first field including the server address; and
a second field indicating acceptance of the server address included in the first field.

16. The communication terminal of claim 11, further comprising if the address value extracted from the confirmation message is a value corresponding to the server address transmitted via the first response message, the control unit generates the second response message to indicate an affirmative response.

17. The communication terminal of claim 11, wherein by confirming an identification number of a transmitting terminal from the request message and the confirmation message, the first and second response messages are transmitted to the identification number.

18. A method of supporting a communication service, comprising:
making a request to a network for a server address required for using the communication service;
receiving a first response message including a specific address value from the network in response to the request;
requesting to the network for an authentication for the address value included in the first response message;
receiving a second response message indicating a result of the authentication from the network; and
accessing the network using the address value included in the first response value if the authentication result indicated by the second response message is affirmative.

19. The method of claim 18, wherein the address value corresponds to an identification number of a domain name server for the communication service.

20. The method of claim 18, wherein the communication service is a packet switching data service.

21. A method of supporting a communication service, comprising:
if a request message requesting a server address is received, transmitting a response message including the server address to a corresponding communication terminal;
if a confirmation message requesting an authentication is received from the communication terminal, comparing an address value included in the confirmation message to the server address; and
if the address value corresponds to the server address, providing an affirmative response to indicate validity of the server address to the communication terminal.

22. The method of claim 21, wherein the server address corresponds to an identification number of a domain name server for the communication service.

23. The method of claim 21, wherein the communication service is a packet switching data service.

24. The method of claim 23, wherein the request message and the response message are packet data protocol context messages for the packet switching data service, respectively.
